(19) United States
(12) Patent Application Publication
(10) Pub. No.: US 2025/0189774 A1
(43) Pub. Date: Jun. 12, 2025

(54) CATADIOPTRIC OPTICAL SYSTEMS FOR VIRTUAL REALITY HEADSETS

(71) Applicant: Samsung Display Co., Ltd., Yongin-si (KR)

(72) Inventors: Bharathwaj Appan Narasimhan, San Jose, CA (US); Hui Chen, Palo Alto, CA (US)

(21) Appl. No.: 18/658,700

(22) Filed: May 8, 2024

Related U.S. Application Data
(60) Provisional application No. 63/608,520, filed on Dec. 11, 2023.

(51) Int. Cl. G02B 17/08; G02B 25/00; G06F 1/16

(52) U.S. Cl. CPC G02B 17/08; G02B 25/001; G06F 1/163

(57) ABSTRACT

In one or more embodiments, an optical system may include a first lens, a second lens, and a stack of reflective polarizer and quarter waveplate between the first lens and the second lens. The stack of reflective polarizer and quarter waveplate may be directly on the first lens, and a half mirror lens by the second lens may be a side opposite the first lens.

### CROSS-REFERENCE TO RELATED APPLICATION

This application claims the priority benefit under 35 U.S.C. § 119 (e) of U.S. Provisional Application No. 63/608,520, filed on Dec. 11, 2023, the disclosure of which is incorporated by reference in its entirety as if fully set forth herein.

### FIELD

The disclosure generally relates to optical systems. More particularly, the subject matter disclosed herein relates to improvements to catadioptric optical systems for viewing optics of a virtual reality headset.

### SUMMARY

Virtual reality (VR) headsets have become very popular in a variety of applications including mobile computing applications and social presence applications. One of the main features of VR headsets is that a small display such as a liquid crystal display (LCD) or an organic light emitting diode OLED display (e.g., OLED micro display or μOLED) can be displayed in front of a user's eyes such that the display appears virtually large (e.g., real life size image on the display). This can be achieved by implementing optical lens arrangements on the VR headset between the display and the user's eyes. However, as VR headsets are worn on the user's head, a big, bulky, heavy headset is uncomfortable and will likely not provide the user with a pleasurable experience. Therefore, techniques to manufacture VR headsets that fit comfortably on a user while achieving a high-resolution image, which mimics real-life scenery is desired.

In one or more embodiments, an optical system may include: a first lens; a second lens; a stack of reflective polarizer and quarter waveplate between the first lens and the second lens, the stack of reflective polarizer and quarter waveplate being directly on the first lens; and a half mirror lens by the second lens at a side opposite the first lens.

The stack of reflective polarizer and quarter waveplate and the second lens may define an air gap between the stack of reflective polarizer and quarter waveplate and the second lens.

The stack of reflective polarizer and quarter waveplate may be directly laminated on the first lens.

The first lens may include at least one flat surface.

The second lens may include a first curved surface at a side facing the stack of reflective polarizer and quarter waveplate, and a second curved surface at a side facing the half mirror lens.

The optical system may further include a third lens between the second lens and the half mirror lens.

The second lens may include a first curved surface at a side facing the stack of reflective polarizer and quarter waveplate, and a second curved surface at a side facing the half mirror lens, and wherein the third lens includes a third curved surface at a side facing the second lens, and a fourth curved surface at a side facing the half mirror lens.

The first lens may include at least one flat surface, the second lens may include a second flat surface at a side facing the stack of reflective polarizer and quarter waveplate, and the second flat surface of the second lens may be directly on the reflective polarizer.

The second lens may include a fifth curved surface at a side facing the third lens, and the third lens may include a third curved surface at a side facing the second lens.

The half mirror lens may include a sixth curved surface at a side facing the display, and the half mirror lens may include a seventh curved surface at a side facing the second lens, the seventh curved surface of the half mirror lens abutting the second seventh curved surface of the third lens.

In one or more embodiments, a virtual reality (VR) headset may include an optical system, including: a first lens; a second lens; a stack of reflective polarizer and quarter waveplate between the first lens and the second lens, the stack of reflective polarizer and quarter waveplate being directly on the first lens; and a half mirror lens by the second lens at a side opposite the first lens.

In one or more embodiments, a method for designing an optical system may include: a first lens; a second lens; a stack of reflective polarizer and quarter waveplate between the first lens and the second lens, the stack of reflective polarizer and quarter waveplate being directly on the first lens; and a half mirror lens by the second lens at a side opposite the first lens, wherein the method may include optimizing the optical system by assigning weights to lens parameters based on pupil position relative to an optical axis of the optical system, and wherein the weights are assigned based on a probability of occurrence of the pupil position.

The lens parameters corresponding to pupil position that are closer to the optical axis may be assigned the highest weight, wherein the lens parameters include track length, focal length, and eyebox size.

In one or more embodiments, a system may include: a display configured to emit light corresponding to an image; and an optical catadioptric system configured to transmit the emitted light to a user, the optical catadioptric system including: a first lens having at least one flat surface; a second lens; a stack of reflective polarizer and quarter waveplate between the first lens and the second lens, the stack of reflective polarizer and quarter waveplate being directly on the at least one flat surface of the first lens; and a third lens which is a half mirror lens, between the second lens and the display.

The reflective polarizer and the second lens may define an air gap between the reflective polarizer and the second lens.

The reflective polarizer may be directly laminated on the at least one flat surface of the first lens.

The second lens may include a first convex surface at a side facing the reflective polarizer, and a first concave surface at a side facing the half mirror lens.

The system may further include a third lens between the second lens and the half mirror lens, wherein the second lens includes a first convex surface at a side facing the reflective polarizer, and a first concave surface at a side facing the half mirror lens, and wherein the third lens includes a second convex surface at a side facing the first lens, and a third convex surface at a side facing the half mirror lens.

The system may further include a third lens between the second lens and the half mirror lens, wherein the second lens includes a first flat surface at a side facing the reflective polarizer, and wherein the first flat surface of the second lens is directly on the reflective polarizer.

The second lens may include a first convex surface at a side facing the third lens, and the third lens may include a second concave surface at a side facing the first lens.

The third lens may include a third concave surface at a side facing the half mirror lens, and wherein the half mirror lens includes a second convex surface at a side facing the third lens, the second convex surface of the half mirror lens abutting the second concave surface of the third lens.

### BRIEF DESCRIPTION OF THE DRAWINGS

In the following section, the aspects of the subject matter disclosed herein will be described with reference to exemplary embodiments illustrated in the figures, in which:

FIG. 1 depicts an example of a virtual reality (VR) headset.

FIG. 2 depicts a side view of the VR headset 200 relative to its position in front of a user's eyes.

FIG. 3 depicts an optical arrangement in an example catadioptric system.

FIG. 4 depicts another optical arrangement of an example catadioptric system, according to one or more embodiments of the present disclosure.

FIG. 5 depicts another optical arrangement of an example catadioptric system, according to one or more embodiments of the present disclosure.

FIG. 6 depicts another optical arrangement of an example catadioptric system, according to one or more embodiments of the present disclosure.

FIG. 7A-7B depict alignment of the viewing optics of the VR headset relative to the eyes of the user for various uses of the headset

FIG. 8 is a flow chart of a method for designing an optical system, according to one or more embodiments of the present disclosure.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

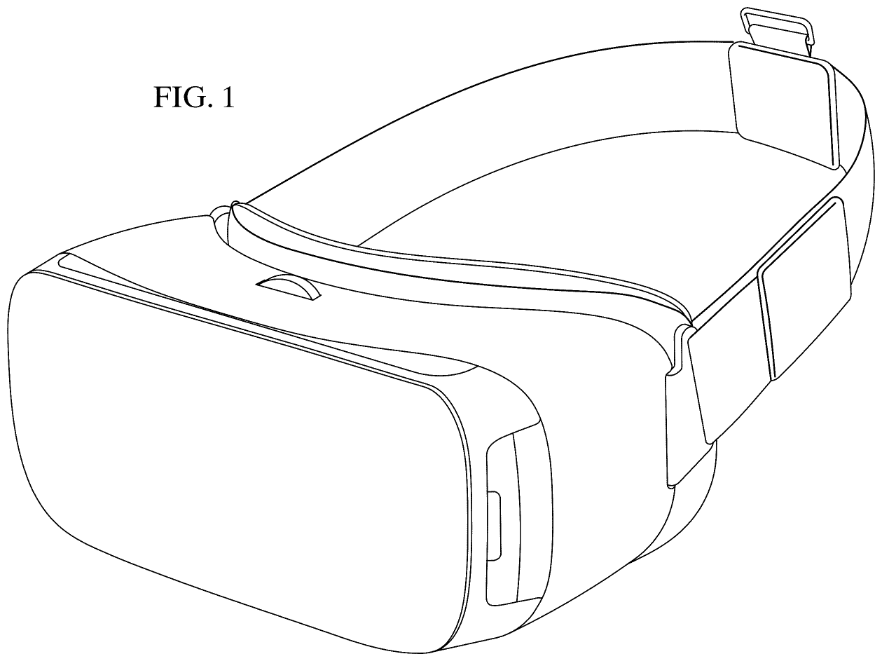

FIG. 1 depicts an example of a virtual reality (VR) headset. While there are many different kinds, an example VR headset may include a small digital display such as an LCD or micro-OLED display (hereinafter “display”), an optical arrangement, and an apparatus to position or mount the headset on a user's head area such that the display and the optical arrangement portion is positioned in front on the user's face and in front of their eyes.

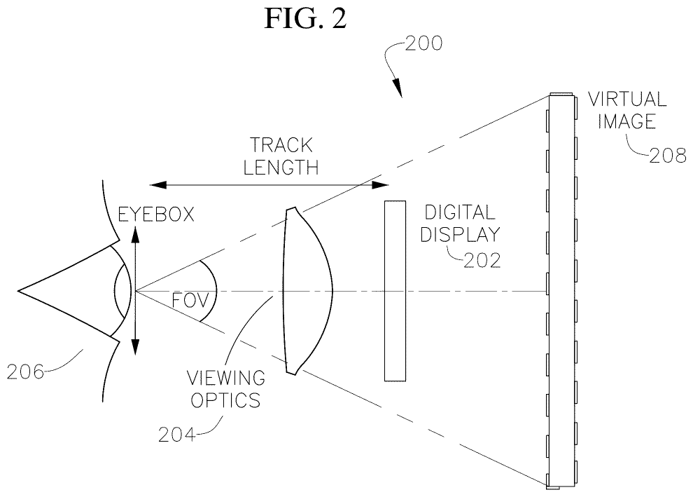

FIG. 2 depicts a side view of the VR headset 200 relative to its position in front of a user's eyes 206. A display 202 may be connected to an electronic device such as a computer or mobile device, and configured to display an image or video, which is projected to the user's eyes 206 through an optical lens arrangement 204. Based on the optical lens arrangement 204, the user sees a larger virtual image 208 of the display 202 instead of the image that appears on the display 202 itself. In order for the user to enjoy the virtual image 208, i.e., the image is of sufficient high resolution and clarity, not only should the display 202 generate a high-resolution image but the optical lens arrangement 204 and the display 202 should be arranged appropriately to transfer the high resolution image generated at the display to the virtual image. Generally, resolution is directly linked to the focal length. In other words, a larger focal length generally allows for a higher resolution image. However, larger focal length result in longer track lengths. As shown in FIG. 2, the track length is the distance between the display 202 and the user's eyes 206. Therefore, a VR headset with a relatively larger track length will result in the headset being farther out (or away) from the user's face, which ultimately results in a larger and bulkier headset. Thus, techniques to shorten the track length while still maintaining a higher resolution is desired.

In some embodiments, the optical lens arrangement 204 may be a catadioptric system. A catadioptric system uses both reflection and refraction to achieve a relatively larger focal point but shortening the track length because the light is not only refracted but also reflected (i.e., light folding) in the catadioptric system to achieve a high-resolution image. Thus, the reflection is achieved through the use of polarization via various polarization filters that may or may not be directly patterned on the lens surface itself.

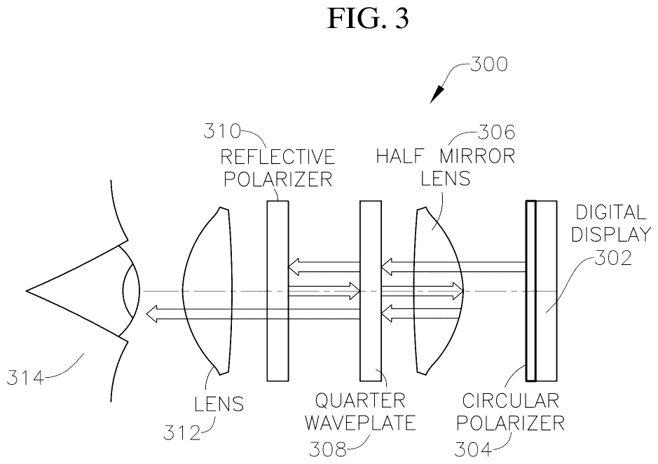

FIG. 3 depicts an optical arrangement in an example catadioptric system 300, according to one or more embodiments of the present disclosure. The catadioptric system may include a lens 312, a reflective polarizer 310, a quarter waveplate 308, a half mirror lens 306, and a circular polarizer 304, all between the user's eye 314 and a display 302. Accordingly, as light from an image displayed on the display 302 propagates toward the eye 314, the light first passes through the circular polarizer 304 where a circular polarization is applied to the light. The circular polarized light then passes through the half mirror lens 306 to the quarter waveplate 308 where the circular polarized light is changed to a linear polarized light. The linear polarized light may then travel to the reflective polarizer 310, and if the axis of the reflective polarizer 310 is orthogonal to the direction of the linear polarized light, then the light is reflected back. If the axis of the reflective polarizer 310 is coincide with the linear polarized light (i.e., not orthogonal), then the light will pass through the reflective polarizer 310. Here, in the first pass, the linear polarized light is orthogonal to the axis of the reflective polarizer 310 and therefore the light will reflect off of the reflective polarizer 310, and back to and through the quarter waveplate 308, where the light is changed back to circular polarized light. The circular polarized light will now go on to the half mirror lens 306, and when the light is reflected back off of the half mirror lens 306, the circular polarized light reserves direction. That is, the circular polarized light changes from, for example, counterclockwise polarization to clockwise polarization. Now, when this circular polarized light passes through the quarter waveplate, it is changed to linear polarization, but because the circular polarization now has an opposite handedness relative to the previous pass, the axis of the linear polarization will also be the opposite of the previously linear polarized light. Now, the axis of the linear polarization coincides with the reflective polarizer 310, the light will pass through the reflective polarizer 310 and go toward and through the lens 312, and on to the user's eye 314. Accordingly, a catadioptric system may be implemented to achieve a shorter track length while still maintaining a relatively large focal point.

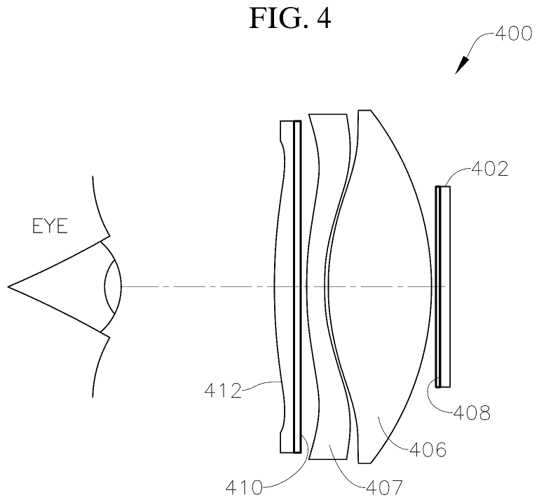

FIG. 4 depicts another optical arrangement of an example catadioptric system 400, according to one or more embodiments of the present disclosure. The catadioptric system 400 may include a first lens 412, a stack of reflective polarizer and Quarter Waveplate (QWP) 410, a second lens 407, a half mirror lens 406, and a circular polarizer 408, all between the user's eye and a display 402 so as to increase (e.g., maximize) the path length of the reflected light before it reaches the user's eye. More specifically, the stack of reflective polarizer and QWP 410 may be placed on the surface of the first lens 412 on the side facing the display 402 or the side facing the eye. In some embodiments, the surface may be substantially a flat surface and the stack 410 may be laminated directly on the flat surface of the first lens 412, on either the front surface facing the eye, or the back surface facing the display. In other instances, the stack 410 may also be placed either independently before the first lens close to the eye accompanied by a protective glass layer or be laminated on to the first surface of the first lens. A second lens 407 may be placed after the first lens 412, close to the display 402, and an air gap may be provided between the first lens 412 and the second lens 407. The half mirror lens 406 may be positioned next to the second lens 407 on the side of the second lens 407 facing the display 402. As shown in FIG. 4, the half mirror lens 406 may be convex on both the side facing the eye and the side facing the display 402. The second lens 407 may have a concave shape on the side facing the half mirror lens 406 such that the concave surface of the second lens and the convex shape of the half mirror lens 406 abut next to each other. The circular polarizer 408 may be positioned on the display 402 and spaced from the half mirror lens 406. More particularly, the circular polarizer 408 may be substantially flat so that it may be laminated directly on the surface of the display 402. By arranging the optics in this manner, the viewing optics of the catadioptric system may result in a high field of view, compact track length, and a larger eyebox, which will be described in more detail later.

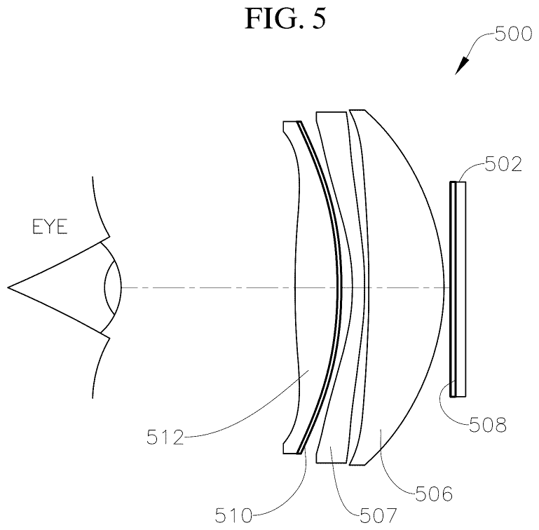

FIG. 5 depicts another optical arrangement of an example catadioptric system 500, according to one or more embodiments of the present disclosure. The catadioptric system 500 may include a first lens 512, a stack of reflective polarizer and Quarter Waveplate (QWP) 510, a second lens 507, a half mirror lens 506, and a circular polarizer 508, all between the user's eye and a display 502. Similar to the embodiment depicted in FIG. 4, the stack of reflective polarizer and QWP 510 may be placed on the surface of the first lens 512 on the side facing the display 502 (i.e., the side opposite the side facing the eye). In some embodiments, the surface may be substantially a curved surface and the stack 510 may be laminated directly on the curved surface of the first lens 512. A second lens 507 may be placed on the side of the stack 510 opposite the first lens 512, and an air gap may be provided between the stack 510 and the second lens 507. The second lens may have a generally curved surface on the side facing the eye, and a curved surface on the side facing the display. The half mirror lens 506 may be positioned adjacent to the second lens 507 on the side facing the display 502. The half mirror lens 506 may have a generally convex or concave surface on the side facing the eye. The half mirror lens 506 also has a convex surface on the side facing the display. In some embodiments, an air gap may be formed between the lens 506 and the display 502. The circular polarizer 508 may be positioned on the display 502 and spaced from the half mirror lens 506. More particularly, the circular polarizer 508 may be substantially flat so that it may be laminated directly on the surface of the display 502. By arranging the optics in this manner, the viewing optics of the catadioptric system may result in a high field of view, compact track length, and a larger eyebox, which will be described in more detail later.

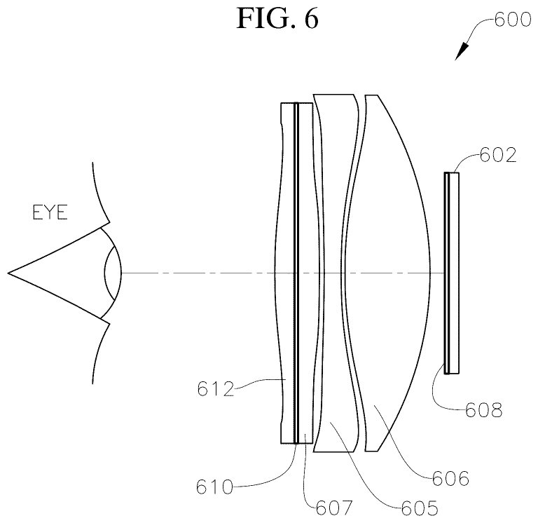

FIG. 6 depicts another optical arrangement of an example catadioptric system 600, according to one or more embodiments of the present disclosure. The catadioptric system 600 may include a first lens 612, a stack of reflective polarizer and Quarter Waveplate (QWP) 610, a second lens 607, a third lens 605, a half mirror lens 606, and a circular polarizer 608, all between the user's eye and a display 602. Similar to the embodiment depicted in FIG. 4, the stack 610 may be placed on the surface of the first lens 612 on the side facing the display 602 (i.e., the side opposite the side facing the eye). In some embodiments, the surface may be substantially a flat surface and the stack 610 may be laminated directly on the flat surface of the first lens 612. A second lens 607 may be placed on the side of the stack 610 opposite the first lens 612. Here, the second lens may also have a substantially flat surface on the side facing the eye, and the substantially flat surface may be laminated directly on the flat surface of the stack 610 on the side facing the display. Accordingly, the stack 610 may be sandwiched between two lenses, thereby creating no air gap between the lenses and the stack 610. The surface of the second lens 607 facing the display 602 may have a convex or concave shape. The third lens 605 may be positioned adjacent to the second lens 607 on the side facing the display 602. In some embodiments, the third lens 605 may have a generally concave or convex surface on the side facing the eye such that the curved surface of the second lens 607 may abut against the third lens 605. The third lens 605 may have a generally convex or concave surface on the side facing the display 602 such that the half mirror lens 606 positioned between the third lens 605 and the display 602 may abut against the third lens 605. The surface of the half mirror lens 606 facing the display 602 may also have a convex shape but an air gap may be formed between the half mirror lens 606 and the display 602. The circular polarizer 608 may be positioned on the display 602 and spaced from the half mirror lens 606. More particularly, the circular polarizer 608 may be substantially flat so that it may be laminated directly on the surface of the display 602. Accordingly, by arranging the catadioptric optics as depicted in FIGS. 4-6, a VR headset can produce higher-resolution video experience while maintaining a relatively compact size so that the user is not burdened with a heavy and bulky headset.

In some embodiments, the one or more lenses of the catadioptric systems described in the embodiments depicted in FIGS. 4-6 may be made of optical grade plastic material and/or glass. Some examples of plastic materials may include but are not limited to Poly(methyl methacrylate) (PMMA), Polystyrene, and/or ZEONEX®. In some embodiments, plastic materials that have zero or close to zero birefringence may be utilized to reduce or minimize any molding related birefringence challenges that may result from molding the refractive polarizer on the lenses. Additionally, the use of plastic materials help in reducing the overall weight of the headset/optics compared to using glass optics, which may be heavier. However, using glass materials may improve optical performance so in some embodiments, the optics may be made from a combination of glass lenses and plastic lenses. For example, one of the lenses may be glass and the rest of the lenses may be plastic material therefore reducing a substantial amount of weight while increasing optical performance.

In addition to implementing a catadioptric system in a VR headset at described above, the alignment of the headset on the user's head also has a substantial impact on the user's experience. More particularly, the alignment of the user's eyes relative to the optical axis of the catadioptric system may impact the performance of the VR headset for the particular user. Therefore, when VR headsets are designed, different positions of the user's eyes are taken into account. Consequently, techniques to improve such design processes are desired.

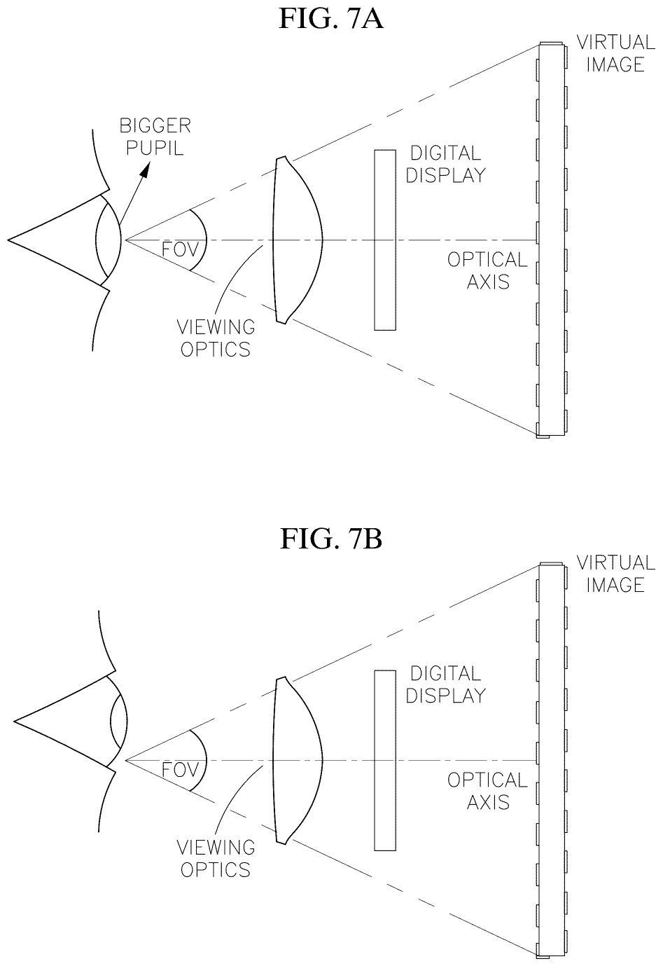

FIG. 7A-7B depict alignment of the viewing optics of the VR headset relative to the eyes of the user. More particularly, FIG. 7A depicts a scenario when an optical axis of viewing optics is aligned to the center of the user's pupils. Because of the optical axis of the viewing optics is centrally aligned (i.e., on-axis) relative to the pupil, the user is able to experience the full performance of the VR headset. In other words, the virtual image will appear to the user as it is intended to be viewed, e.g., at its best resolution. However, in some instances, the VR headset may not fit well on the head of the user, for example, because the user's head may be too small or too big, or the straps on the VR headset may be worn out and is unable to be snuggly tightened around the user's head. Therefore, the VR headset may rest too high or too low on the user's face (as shown in FIG. 7B), and the optical axis may not be in alignment with the user's pupils.

Additionally, because the size of the pupils change depending on the environment (i.e., the pupils enlarge in darker environments whereas they contract in brighter environment), when the pupils contract, the VR headset may become misaligned. To reduce the likelihood of such misalignment, VR headsets may be designed with a relatively large eyebox to keep the user's pupils within the range of the optical axis. An eyebox may be defined as a zone formed around the optical axis in which the user's pupil may be positioned and still achieve an acceptable perceived virtual image (e.g., a non-degraded, non-blurry, non-distorted virtual image). In other words, as long as the pupils are within the zone of the eyebox (i.e., the pupils are within the range of distance of the eyebox zone relative to the optical axis), the virtual image may appear non-degraded to the user. On the other hand, if the user's pupils fall outside of the zone of the eyebox, then the perceived virtual image will appear degraded to the user.

However, instead of designing a VR headset that accommodates the largest possible pupil, or the greatest misalignment of the pupils from the optical axis, an improved method of designing the viewing optics may be envisaged based on the frequency of occurrence of the different pupil sizes and the locations of the pupils relatively to the optical axis, according to one or more embodiments of the present disclosure.

The nominal pupil size for adults is about 4 mm, and most users position the VR headset so that it rests on their head properly and the optical axis aligns with their pupils. However, pupil location relative to the optical axis may vary, for example, it may range from 2 to 10 mm from the nominal pupil location with each pupil location having a different probability of occurrence. For example, there is a greater likelihood of the pupil being on-axis at the nominal position relative to the optical axis because a user will usually try to position the pupil as close as possible to the nominal position when attempting to wear the VR headset. Based on this logic, and according to one or more embodiments of the present disclosure, a data set including all of such pupil locations may be taken into account when designing the lenses for the viewing optics by assigning a weight to each individual displaced pupil location according to the probability of their occurrence. Thus, the locations with the higher probability of occurrence will have a higher weight and the locations with the lower probability of occurrence will have a lower weight. Then the collection of this information may be provided to an optimization engine of an optical software, known to those having ordinary skill in the art, and generate unique lens profiles, which may result in a more consistent eyebox imaging performance. The steps taken by the optical software are beyond the scope of the embodiments of the present disclosure and therefore will not be described herein.

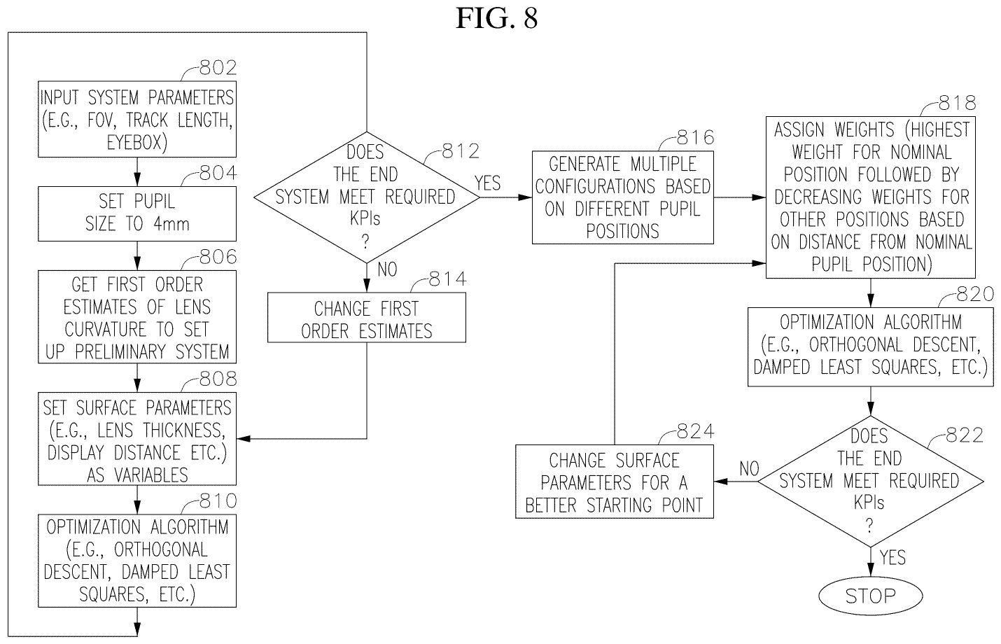

FIG. 8 is a flow chart of a method for designing an optical system for a VR headset, according to one or more embodiments of the present disclosure. First, initial system parameters such as the field of view (FOV), track length, and eyebox, may be determined (step 802), and the nominal pupil size for adults may be set, for example, to 4 mm (step 804). It should be noted that other pupil sizes may be utilized, for example, the nominal pupil size for kids, in order to design an optical system for kids or people with smaller sized head. Next, a first order estimate of lens curvature may be determined to set up a preliminary system (step 806). Next, surface parameters of the lens may be determined as variables (step 808). For example, surface parameters may include the thickness of the lens, distance of the display the lens, etc. Next, the initial system parameters, the pupil size, first order estimate of the lens curvature, and the surface parameters, may be optimized by an optimization engine (step 810). In some embodiments, the optimization engine may utilize one or more optimization algorithms such as orthogonal descent, damped leased squares, and/or other algorithms to optimize the optical profiles. Next, a determination is made as to whether the optimized optical profile satisfies certain key performance indicators (KPIs) (step 812). If the KPIs are not satisfied, then the first order estimates may be changed (step 814) and the surface parameters may be determined again at step 808. If the KPIs are satisfied, then a plurality of configurations may be generated based on different pupil positions, e.g., position of the pupil relative to the optical axis as previously described with reference to FIGS. 7A-7B (step 816). For each pupil position, a weight is assigned, wherein the highest weight is assigned to the nominal pupil position (e.g., pupil that is positioned in alignment with the optical axis), with decreasing weight assigned to pupil positions that are farther from the nominal pupil position (step 818). In other words, the farther from the nominal pupil position, the lower the weight. Each of the plurality of configurations may be optimized again by the optimization engine (step 820) and if the optimized configurations satisfy the KPIs, then the optical system design is complete (step 826) and it may now be assembled. If the optimized configurations do not satisfy the KPIs, then the surface parameters may be changed and steps 818 and 820 may be repeated until the KPIs are satisfied (step 822).

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims and their equivalents.

1 what is claimed is:

1. An optical system, comprising:
a first lens;
a second lens;
a stack of reflective polarizer and quarter waveplate between the first lens and the second lens, the stack of reflective polarizer and quarter waveplate being directly on the first lens; and
a half mirror lens by the second lens at a side opposite the first lens.

2. The optical system of claim 1, wherein the stack of reflective polarizer and quarter waveplate and the second lens define an air gap between the stack of reflective polarizer and quarter waveplate and the second lens.

3. The optical system of claim 1, wherein the stack of reflective polarizer and quarter waveplate is directly laminated on the first lens.

4. The optical system of claim 3, wherein first lens comprises at least one flat surface.

5. The optical system of claim 1, wherein the second lens comprises a first curved surface at a side facing the stack of reflective polarizer and quarter waveplate, and a second curved surface at a side facing the half mirror lens.

6. The optical system of claim 1, further comprising a third lens between the second lens and the half mirror lens.

7. The optical system of claim 6,
wherein the second lens comprises a first curved surface at a side facing the stack of reflective polarizer and quarter waveplate, and a second curved surface at a side facing the half mirror lens, and
wherein the third lens comprises a third curved surface at a side facing the second lens, and a fourth curved surface at a side facing the half mirror lens.

8. The optical system of claim 6,
wherein the first lens comprises at least one flat surface,
wherein the second lens comprises a second flat surface at a side facing the stack of reflective polarizer and quarter waveplate, and
wherein the second flat surface of the second lens is directly on the reflective polarizer.

9. The optical system of claim 8,
wherein the second lens comprises a fifth curved surface at a side facing the third lens, and
wherein the third lens comprises a third curved surface at a side facing the second lens.

10. The optical system of claim 9,
wherein the half mirror lens comprises a sixth curved surface at a side facing a display, and
wherein the half mirror lens comprises a seventh curved surface at a side facing the second lens, the seventh curved surface of the half mirror lens abutting the seventh curved surface of the third lens.

11. A virtual reality (VR) headset comprising:
an optical system, comprising:
a first lens;
a second lens;
a stack of reflective polarizer and quarter waveplate between the first lens and the second lens, the stack of reflective polarizer and quarter waveplate being directly on the first lens; and
a half mirror lens by the second lens at a side opposite the first lens.

12. A method for designing an optical system comprising:
a first lens;
a second lens;
a stack of reflective polarizer and quarter waveplate between the first lens and the second lens, the stack of reflective polarizer and quarter waveplate being directly on the first lens; and
a half mirror lens by the second lens at a side opposite the first lens, the method comprising:
optimizing the optical system by assigning weights to lens parameters based on pupil position relative to an optical axis of the optical system,
wherein the weights are assigned based on a probability of occurrence of the pupil position.

13. The method of claim 12, wherein the lens parameters corresponding to pupil position that are closer to the optical axis is assigned the highest weight,
wherein the lens parameters comprise track length, focal length, and eyebox size.

14. A system, comprising:
a display configured to emit light corresponding to an image; and
an optical catadioptric system configured to transmit the emitted light to a user, the optical catadioptric system comprising:
a first lens having at least one flat surface;
a second lens;
a stack of reflective polarizer and quarter waveplate between the first lens and the second lens, the stack of reflective polarizer and quarter waveplate being directly on the at least one flat surface of the first lens; and
a third lens which is a half mirror lens, between the second lens and the display.

15. The system of claim 14, wherein the reflective polarizer and the second lens define an air gap between the reflective polarizer and the second lens.

16. The system of claim 14, wherein the reflective polarizer is directly laminated on the at least one flat surface of the first lens.

17. The system of claim 14, wherein the second lens comprises a first convex surface at a side facing the reflective polarizer, and a first concave surface at a side facing the half mirror lens.

18. The system of claim 14, further comprising a third lens between the second lens and the half mirror lens,
wherein the second lens comprises a first convex surface at a side facing the reflective polarizer, and a first concave surface at a side facing the half mirror lens, and
wherein the third lens comprises a second convex surface at a side facing the first lens, and a third convex surface at a side facing the half mirror lens.

19. The system of claim 14, further comprising a third lens between the second lens and the half mirror lens,
wherein the second lens comprises a first flat surface at a side facing the reflective polarizer, and
wherein the first flat surface of the second lens is directly on the reflective polarizer.

20. The system of claim 19,
wherein the second lens comprises a first convex surface at a side facing the third lens, and
wherein the third lens comprises a second concave surface at a side facing the first lens.

21. The system of claim 20,
wherein the third lens comprises a third concave surface at a side facing the half mirror lens, and
wherein the half mirror lens comprises a second convex surface at a side facing the third lens, the second convex surface of the half mirror lens abutting the second concave surface of the third lens.
